(19) United States
(12) Patent Application Publication
(10) Pub. No.: US 2018/0262491 A1
(43) Pub. Date: Sep. 13, 2018

(54) METHOD, APPARATUS, AND CLIENT TERMINAL DEVICE FOR IMPLEMENTING WEBSITE FINGERPRINT LOGIN

(71) Applicant: GUANGZHOU UCWEB COMPUTER TECHNOLOGY CO., LTD., Guangzhou (CN)

(72) Inventor: Lingling LIU, Guangzhou (CN)

(21) Appl. No.: 15/779,488

(22) PCT Filed: Nov. 15, 2016
(86) PCT No.: PCT/CN2016/105884

§ 371 Date: May 25, 2018

(30) Foreign Application Priority Data
Nov. 26, 2015 (CN) 201510843335.4

(51) Int. Cl. H04L 29/06; G06F 21/32

(52) U.S. Cl. CPC H04L 63/0861; G06F 21/32; H04L 63/20

(57) ABSTRACT

Method, apparatus, and client terminal device for implementing website fingerprint login are provided. The method includes obtaining fingerprint information to login at least one website from a fingerprint sensor; searching for a login-information configuration file corresponding to the fingerprint information; and auto-filling a login page of the at least one website with the login information found in the login-information configuration file. The login-information configuration file includes website information of the at least one website and login information of the website. As such, rapid and secure multi-website login and convenient switching between multiple fingerprints can be achieved.

### TECHNICAL FIELD

The present application relates to a client terminal application of a browser and, in particular to method and corresponding apparatus and client terminal device for implementing website fingerprint login.

### BACKGROUND

With the development of society and technology, a client terminal device, which provides convenient and fast-speed communication means for people, particularly, the mobile client terminal device becomes more and more popular. The fingerprint identification function of some devices is favored by more and more device manufacturers and users because it is fast, convenient to operate and has high recognition accuracy and high security level. Due to the fact that the client terminal device is updated frequently, it is believed that in the near future, the fingerprint identification will become a standard configuration for the client terminal device. Nowadays, the fingerprint identification is mainly used for identity verification and security payment.

On the other hand, a user needs to perform account login operation frequently in daily webpage access. If the user needs to re-input the username and password each time, it wastes a lot of time and energy. Thus, a lot of pages have options for saving the account and password, and even if the page does not provide the option, many browsers have the function. Saving the account and password introduces the following problems:
1. Privacy and security hazards are easy to occur. For example, when the mobile phone is lost or stolen, other people can use the browser which stores the account and password for all the websites to carry out the account operation freely;
2. Browsing across terminals is inconvenient. The information stored by the user in a browser on one terminal usually cannot be directly used on other terminals and the account and password need to be re-input for every website. It is inconvenient, and the account leakage can easily happen; and
3. The switching of account to browse is inconvenient. Automatically storing the account and password is applicable to one account. The login of a second account will generally replace the information of the first account.

Therefore, there is a need for a browser implementation method to solve at least one of the above discussed problems.

### BRIEF SUMMARY OF THE DISCLOSURE

To solve the problem along with the conventional account password storage, incorporated with the fingerprint identification technology, the present application provides a new mechanism for storing the page account login information for a browser. Or in other words, the present application provides a method for converting a page account login mode into a fingerprint identification method, a corresponding apparatus, and a client terminal device.

One aspect of the present disclosure provides a method for implementing a website fingerprint login, including obtaining fingerprint information to login at least one websites from a fingerprint sensor; searching for a login-information configuration file corresponding to the fingerprint information, where the login-information configuration file includes website information of the at least one website and login information of the website; and auto-filling a login page of the at least one website with the login information found in the login-information configuration file.

As such, it is convenient for the user to login while protecting the user's privacy. In addition, due to the fact that the login-information configuration file, which corresponds to the fingerprint information and includes the website and the login information, is used instead of the saved data for the specific website by the cookie or the like, the fingerprint identification of the login information of a plurality of websites can be realized so as to facilitate the user's login and account switching operation.

Optionally, the method further includes: when a request for matching new fingerprint information with new login information is received, obtaining the new login information and website information of a website which the new login information belongs to; obtaining, from the fingerprint sensor, the new fingerprint information matched with the new login information; generating a new login-information configuration file corresponding to the new fingerprint information; and adding the new login information and the website information of the website to the new login-information configuration file, and saving the new login-information configuration file.

Thus, it is convenient to use new fingerprint to login a website by generating a login-information configuration file, and it is possible to realize the original fingerprint login of a website, the login of the same website by another username, or the login of different type of websites with the corresponding fingerprints respectively.

Optionally, the method further includes: when a request for matching the fingerprint information with new login information is received, obtaining the new login information and website information of a website which the new login information belongs to; obtaining, from the fingerprint sensor, the fingerprint information matched with the new login information; and adding the new login information and the website information of the website which the new login information belongs to the login-information configuration file corresponding to the fingerprint information, and saving the login-information configuration file.

Thus, when the fingerprint is already used to login other websites, it will be convenient to use the fingerprint to login the new website by updating the login-information configuration file and user operation is facilitated.

Optionally, the method further includes synchronizing the login-information configuration file to a server, where searching for the login-information configuration file corresponding to the fingerprint information includes: searching for the login-information configuration file corresponding to the fingerprint information locally; and when the login-information configuration file corresponding to the login information is not found locally, sending the fingerprint information to the server, requesting the server to search for the login-information configuration file corresponding to the fingerprint information, and receiving the login-information configuration file from the server.

Therefore, through cloud storage of the configuration file, the cross-terminal fingerprint login can be conveniently realized, so that user operation is further facilitated. In addition, the login-information configuration file corresponding to the fingerprint information is searched locally first; and when the login-information configuration file corresponding to the login information is not found locally, cloud is searched. Thus, fast login on the same terminal and the cross-terminal login can be conveniently realized, so that user operation is further facilitated.

Another aspect of the present disclosure provides an apparatus for implementing website fingerprint login, including: a fingerprint information acquisition unit, configured to obtain fingerprint information to login at least one website from a fingerprint sensor; a configuration file searching unit, configured to search for a login-information configuration file corresponding to the fingerprint information, where the login-information configuration file includes website information of the at least one website and login information of the website; and a login information auto-filling unit, configured to automatically fill a login page of the at least one website with the login information found in the login-information configuration file.

Optionally, the apparatus further includes: a website/login information acquisition unit, when the website/login information acquisition unit receives a request for matching new fingerprint information with new login information, configured to obtain the new login information and website information of a website which the new login information belongs to; the fingerprint information acquisition unit, configured to obtain, from the fingerprint sensor, the new fingerprint information matched with the new login information from the fingerprint sensor; a configuration file generation unit, configured to generate a new login-information configuration file corresponding to the new fingerprint information; and a configuration file updating unit, configured to add the new login information and the website information of which the new login information belongs to the new login-information configuration file, and saves the new login-information configuration file.

Optionally, the apparatus further includes: a website/login information acquisition unit, when a request for matching the fingerprint information with new login information is received, configured to obtain the new login information and website information of a website which the new login information belongs to; the fingerprint information acquisition unit, configured to obtain, from the fingerprint sensor, the new fingerprint information matched with the new login information from the fingerprint sensor; and a configuration file updating unit, configured to add the new login information and the website information of the website which the new login information belongs to the login-information configuration file corresponding to the fingerprint information, and save the login-information configuration file.

Optionally, the apparatus further includes a communication unit, configured to synchronize the login-information configuration file to a server.

Optionally, the configuration file searching unit includes: a local searching unit, configured to search for the login-information configuration file corresponding to the fingerprint information locally, where the communication unit further configured to, when the login-information configuration file corresponding to the login information is not found locally, send the fingerprint information to the server, request the server to search for the login-information configuration file corresponding to the fingerprint information, and receive the login-information configuration file from the server.

Another aspect of the present disclosure provides a client terminal device, including: a fingerprint sensor, configured to obtain fingerprint information to login at least one website; a memory, configured to save a login-information configuration file corresponding to the fingerprint information, where the login-information configuration file includes website information of the at least one website and login information of the website; and a processor, configured to search the memory for the login-information configuration file corresponding to the fingerprint information and auto-fill a login page of the at least one website with the login information found in the login-information configuration file.

Optionally, the client terminal device further includes an input module, configured to fill the login page of a website with new login information and input a request for matching new fingerprint information with the new login information, where the processor obtains, from the fingerprint sensor, the new fingerprint information matched with the new login information, generates a new login-information configuration file corresponding to the new fingerprint information, adds the new login information and the website information of the website which the new login information belongs to the new login-information configuration file, and saves the new login-information configuration file.

Optionally, the client terminal device further includes an input module, configured to fill the login page of a website with new login information and input a request for matching new fingerprint information with the new login information, where the processor obtains, from the fingerprint sensor, the fingerprint information matched with the new login information, adds the new login information and the website information of the website which the new login information belongs to the login-information configuration file, and saves the login-information configuration file.

Optionally, the client terminal device further includes: a communication module, configured to synchronize the login-information configuration file to a server, where when the login-information configuration file corresponding to the login information is not found locally, the processor, through the communication module, sends the fingerprint information to the server, requests the server to search for the login-information configuration file corresponding to the fingerprint information, and receives the login-information configuration file from the server.

Another aspect of the present disclosure provides a computer readable medium on which a computer program for executing the above disclosed methods is saved.

Thus, by using the method for implementing fingerprint registration, the corresponding device and the client terminal device, the multi-website login information or the fingerprints of multiple user login information of the same website can be correspondingly logged in through the browser, so that the security and convenience of website access are improved. In addition, the cross-terminal login can be realized safely through cloud storage.

### BRIEF DESCRIPTION OF THE DRAWINGS

The accompanying drawings describe the disclosed exemplary embodiments of the invention in more detail. The above disclosure and other objects, features and advantages will become more obvious. The same reference number will refer to the same part in the disclosed exemplary embodiments.

FIG. 1 is a schematic flowchart of a method for implementing website fingerprint login according to one embodiment of the present invention;

FIG. 2 is a schematic flowchart of steps of generating a configuration file of a method for implementing website fingerprint login according to another embodiment of the present invention;

FIG. 3 is a schematic flowchart of steps of updating a configuration file of a method for implementing website fingerprint login according to another embodiment of the present invention;

FIG. 4 is a schematic block diagram of an apparatus for implementing webpage fingerprint login according to another embodiment of the present invention; and

FIG. 5 is a diagram of a client terminal device according to another embodiment of the present invention.

### DETAILED DESCRIPTION

The optional embodiments of the present disclosure will be described in more detail below with reference to the accompanying drawings. Although the optional embodiments of the present disclosure are shown in the drawings, it should be understood that the present disclosure may be implemented in a variety of forms and should not be limited by the embodiments set forth herein. Rather, the embodiments are provided so that the disclosure is more thorough and complete, and the scope of the present disclosure can be completely relayed to those skilled in the art.

The invention discloses a method for implementing fingerprint website login through a browser. By saving the corresponding information in a configuration file matched with the fingerprint information, fingerprint login of a plurality of websites can be realized by using the same browser. It is convenient for the user to login and protects the privacy by a method of scanning the fingerprint instead of saving the account. In addition, the method can also realize the recording of the cross-terminal login information by using a server storage mechanism. Thus, as long as the user associates the account and password to the fingerprint once, the user can login by scanning the fingerprints on any device. Further, the switching can be easily realized by associating fingerprints with different fingers for a scenario when switching between multiple users to login the same website.

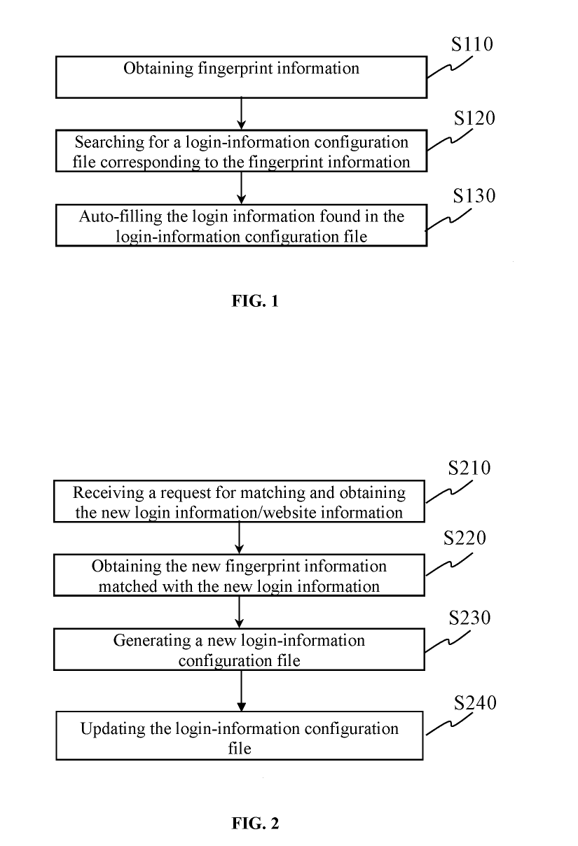

FIG. 1 is a schematic flowchart of a method for implementing website fingerprint login according to one embodiment of the present invention.

In Step S110, fingerprint information to login a website is obtained from a fingerprint sensor.

In Step S120, a login-information configuration file corresponding to the fingerprint information is searched. The login-information configuration file includes website information and login information of the website.

In Step S130, the login information found in the login-information configuration file automatically fills a login page of the website.

The fingerprint information for the website login is obtained by the fingerprint sensor and is associated with the website and the login information of the website. It is convenient for the user to login while protecting the user's privacy. In addition, due to the fact that the login-information configuration file, which corresponds to the fingerprint information and includes the website and the login information, is used instead of the stored data for the specific website by the cookie or the like, the fingerprint identification of the login information of a plurality of websites can be realized so as to facilitate the user's login and account switching operation.

In an optional embodiment, the method can further include generating a login-information configuration file when the fingerprint information is associated with the website and the login information of the website for the first time.

In an optional embodiment, the method may further include updating the login-information configuration file.

FIG. 2 is a schematic flowchart of steps of generating a configuration file for a method for implementing website fingerprint login according to another embodiment of the present invention.

In Step S210, when a request for matching new fingerprint information with new login information is received, the new login information and the website information of a website which the new login information belongs to are obtained.

In Step S220, the new fingerprint information matched with the new login information is obtained from the fingerprint sensor.

In Step S230, a new login-information configuration file corresponding to the new fingerprint information is generated.

In Step S240, the new login information and the website information of a website which the new login information belongs to are added to the new login-information configuration file, and the new login-information configuration file is saved.

When the website is logged in by using the new fingerprint information for the first time, or when new fingerprint information needs to be used for matching different login information to login the same website, a configuration file may be generated for the new fingerprint information, so that the website can be conveniently logged in using the fingerprint. It should be understood by those skilled in the art that the configuration file may be generated before the fingerprint login method as shown in FIG. 1. If a second or a third fingerprint is introduced, the configuration file may be generated after the fingerprint login method as shown in FIG. 1 or the introduction of the fingerprint and the generation of the configuration file may interweave according to actual usage scenario.

FIG. 3 is a schematic flowchart of steps of updating a configuration file of a method for implementing website fingerprint login according to another embodiment of the present invention.

In Step S310, when the request for matching the fingerprint information with the new login information is received, the new login information and the website information of the website which the new login information belongs to are obtained.

In Step S320, the new fingerprint information matched with the new login information is obtained from the fingerprint sensor.

In Step S330, the login information and the website information of the website which the new login information belongs to are added to the login-information configuration file corresponding to the fingerprint information, and the login-information configuration file is saved.

When the website is logged in by using the fingerprint information of an existing login-information configuration file, the website and the login information, which are requested be matched with the fingerprint information, can be added directly, so that website can be conveniently logged in using the fingerprint. It should be understood by those skilled in the art that the update of the configuration file may occur before or after each time the fingerprint login is used, or the update and the fingerprint login may interweave according to actual usage scenario.

In an optional embodiment, the method further includes synchronizing the login-information configuration file to a server. For example, when searching for a login-information configuration file corresponding to the fingerprint information, the login-information configuration file corresponding to the fingerprint information may be searched locally first. When no login-information configuration file can be found locally, the fingerprint information can be sent to the server, the server is requested to look for a login-information configuration file corresponding to the fingerprint information, and the login-information configuration file may be received from the server.

Therefore, through cloud storage of the login-information configuration file, the cross-terminal fingerprint login can be conveniently realized, so that user operation is further facilitated.

Any one of the above methods can be realized by a browser. The generation, update, and storage of the login-information configuration file is realized through the local storage of the browser, the limitation of the cookie to a single website can be breached and the limitation on the client terminal may be further breached through the storage of the server.

In an optional embodiment, the fingerprint information may be, for example, a unique character string, such as a touchID, generated by the fingerprint sensor by calculating the fingerprint eigenvalue. Or the fingerprint information may be information partially matching the touchID, which is previously recorded and generated from the complete fingerprint information. For example, a user may provide information of a complete fingerprint when the user logs in the terminal by using fingerprints for the first time and only a certain proportion of the fingerprint information needs to be provided for each following usage.

A specific embodiment for implementing website fingerprint login by a browser on the user side is described below.

On a client terminal device (e.g., a smart phone) with a fingerprint identification function, when the user accesses the account login page, the browser can pop out a prompt box “whether to use the fingerprint login”. If the user has already matched fingerprint for the account, the user clicks the confirmation and scans the fingerprint information. The browser preferentially searches for matching configuration files locally according to the scanned fingerprint information. If not found locally, the fingerprint information will be uploaded to a server, and searching is performed on the server. If the corresponding configuration file is found, a recovery algorithm is automatically saved according to a form and a login information (e.g., a username and a password or an account number and a password) corresponding to the website will be found in the configuration file and then auto-filling is performed. After the account and the password are automatically filled, the account automatically logs in and the user can then access the website logged in page.

If the user does not use fingerprint to save the account and the password of the website before, a normal process needs to be followed. The account number and the password are input in the login box, and the login button is clicked. The browser then pops up a prompt box “Whether to use the fingerprint to save the username and password.” If the user selects “Yes”, fingerprint information, such as a touchID, is collected through the fingerprint sensor. Then the browser may generate a configuration file, and the configuration file is named as a touchID string so that the configuration file is associated with the touchID. Then the webpage URL, the user account name, the password and other information are written into the configuration file and the configuration file is synchronized to the server. When the user accesses the website again, relevant information, such as the saved account name and password, which matches with the fingerprint, automatically fills the login box to automatically login and jump to next page.

In addition, if frequently switching between multiple users is needed, the user can associate different account and password with different fingers. For example, the fingerprint 1 is used for matching with the login account a, and the fingerprint 2 is used for matching with the login account b. Then when the website is accessed, when the finger 1 is scanned, the account a can be logged in, and the account number b is logged in when the finger 2 is scanned. The present application achieves an extremely convenient effect which cannot be realized by the existing account saving function.

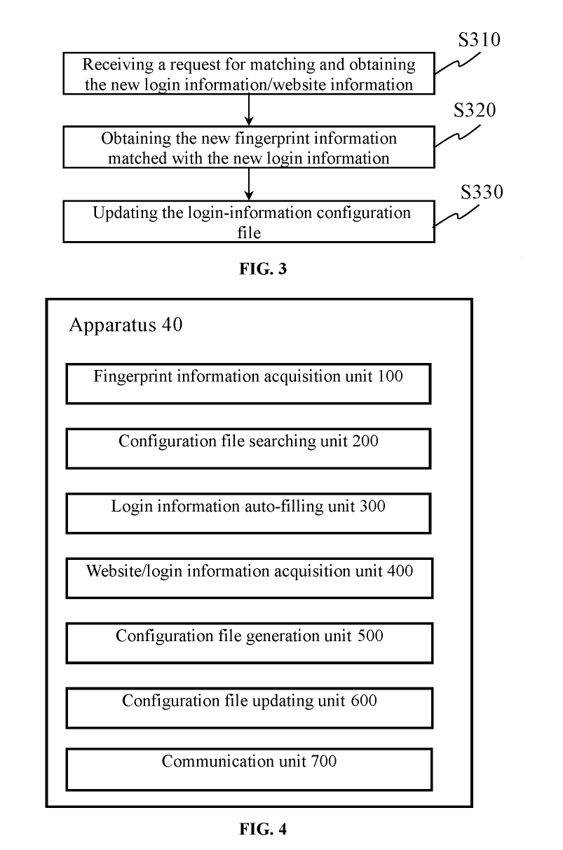

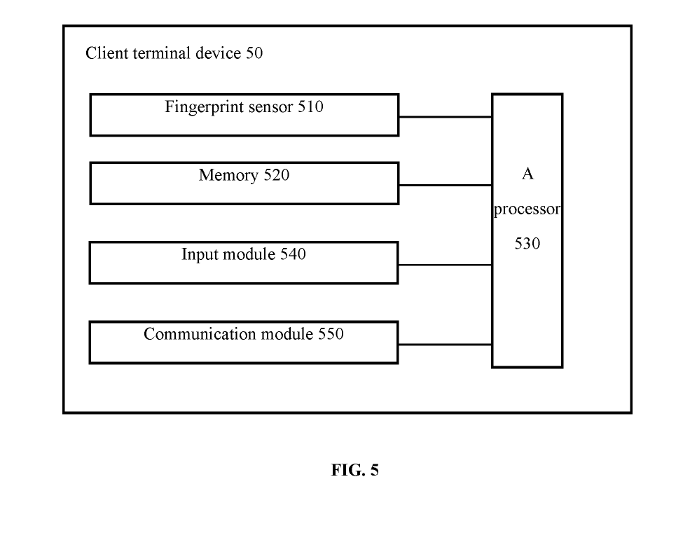

The website fingerprint login method is described above with reference to FIGS. 1-3. An apparatus and a client terminal device are described below with reference to FIG. 4 and FIG. 5.

The functions of the apparatus and many units of the client terminal described below are respectively the same as the functions in above referred FIG. 1 and the corresponding steps described in the following specific embodiment. In order to avoid repetition, the description is focused on cell structures of the apparatus. Some detail description will not be repeated, and reference can be made to the above corresponding description.

FIG. 4 is a schematic block diagram of an apparatus for implementing webpage fingerprint login according to another embodiment of the present invention

As shown in FIG. 4, the apparatus 40 includes a fingerprint information acquisition unit 100, a configuration file searching unit 200, and a login information auto-filling unit 300.

The fingerprint information acquisition unit 100 obtains fingerprint information to login a website from a fingerprint sensor.

The configuration file searching unit 200 searches for a login-information configuration file corresponding to the fingerprint information. The login-information configuration file includes website information of the website and login information of the website.

The login information auto-filling unit 300 automatically fills a login page of the website with the login information found in the login-information configuration file.

Optionally, the apparatus 40 may further include a website/login information acquisition unit 400, a configuration file generating unit 500, and a configuration file updating unit 600.

When the website/login information acquisition unit 400 receives a request for matching the new fingerprint information with the new login information, the new login information and the website information of the website which the new login information belongs to are obtained.

The fingerprint information obtaining unit 100 obtains the new fingerprint information matched with the new login information from the fingerprint sensor.

The configuration file generation unit 500 generates a new login-information configuration file corresponding to the new fingerprint information.

The configuration file updating unit 600 adds the new login information and the website information of which the new login information belongs to the new login-information configuration file, and saves the new login-information configuration file.

Optionally, to match the fingerprint information of the existing configuration file, the configuration file updating unit 600 can directly add the website and the login information obtained by the website/login information obtaining unit 400 to the configuration file.

Optionally, the apparatus may further include a communication unit 700. The communication unit 700 can be used for synchronizing the login-information configuration file to a server. The configuration file searching unit 200 may include a local searching unit 210. The local searching unit 210 searches for the login-information configuration file corresponding to the fingerprint information locally. When the login-information configuration file corresponding to the fingerprint information was not found locally, the communication unit 700 may send the fingerprint information to the server, request the server to look up the login-information configuration file corresponding to the fingerprint information, and receive the login-information configuration file from the server.

FIG. 5 is a diagram of a client terminal device according to another embodiment of the present invention.

As shown in FIG. 5, the client terminal device 50 includes a fingerprint sensor 510, a memory 520, a processor 530, an optional input module 540, and a communication module 550.

The fingerprint sensor 510 obtains fingerprint information of a login website. The memory 520 saves a login-information configuration file corresponding to the fingerprint information. The login-information configuration file includes website information of the website and login information of the website. The processor 530 searches on the memory for the login-information configuration file corresponding to the fingerprint information. The login information found in the login-information configuration file fills the login page of the website.

Optionally, the client terminal device further includes an input module 540. The input module is used for filling the login information in the login page of the website and inputting the request to match the fingerprint information with the login information. The processor 530 obtains fingerprint information matched with the login information from the fingerprint sensor 510. If the fingerprint information is new fingerprint information, a login-information configuration file for the fingerprint information is generated, the website information of the website which the new login information belongs to and the login information are added to the login-information configuration file corresponding to the fingerprint information, and the login-information configuration file is saved. If the login-information configuration file is not new fingerprint information, the matching file of the fingerprint information is directly updated.

Optionally, the client terminal device further includes a communication module 550. The communication module 550 is used for synchronizing the login-information configuration file to a server. When the processor 530 cannot find the login-information configuration file corresponding to the fingerprint information locally, the fingerprint information is sent to the server through the communication module 550, the server is requested to search for the login-information configuration file corresponding to the fingerprint information, and the login-information configuration file is received from the server.

The method and the corresponding apparatus and terminal device for implementing the website fingerprint login according to the present application are described above in detail with reference to the accompanying drawings.

In addition, the method can also be implemented as a computer program. The computer program may include computer program code instructions for executing the steps defined in the method of the present invention. Alternatively, the method according to the invention can also be implemented as a computer program product. The computer program product may include a computer readable medium, a computer program for executing the functions defined in the method of the present invention saved on the computer readable medium. Those skilled in the art will also appreciate that various exemplary logical blocks, modules, circuits and algorithm steps described in connection in the disclosure herein can be implemented as electronic hardware, computer software, or a combination of the two.

The accompanying flowcharts and block diagrams in the drawings show multiple systems, methods, and system structure, and functions according to embodiments of the present invention. In this regard, each block in the flowcharts or block diagrams may represent a module, a program segment, or a portion of the instructions. The module, the program segment, or a portion of the instructions includes one or more executable instructions for achieving a specified logical function. It should be noted that in some alternative implementations, the functions noted in the blocks may also occur in an order different from the order indicated in the drawings. For example, two consecutive blocks may be executed substantially in parallel, and sometimes they may be performed in reversed order depending on the functions involved in the present invention. It should also be noted that, each block in the block diagrams and/or the flowcharts and a combination of the blocks in the block diagrams and/or the flowcharts may be implemented by a special hardware-based system which performs specified functions or actions. They may also be implemented by a combination of special hardware and computer instructions.

The embodiments of the present invention have been described above. The above description is exemplary and is not exhaustive, and is not limited by the disclosed embodiments. Without departing from the scope and spirit of the illustrated embodiments, many modifications and variations will be obvious to those with ordinary skill in the art. The terms used herein are selected to best explain the principles of the embodiments, practical application or technical improvement in the market, or make ordinary skilled in the art to understand all the disclosed embodiments in the present invention.

What is claimed is:

1. A method for implementing website fingerprint login, comprising:
obtaining fingerprint information to login at least one website from a fingerprint sensor;
searching for a login-information configuration file corresponding to the fingerprint information, wherein the login-information configuration file includes website information of the at least one website and login information of the corresponding at least one website; and
auto-filling a login page of the at least one website with the login information found in the login-information configuration file.

2. The method according to claim 1, further comprising:
when a request for matching new fingerprint information with new login information is received, obtaining the new login information and website information of a web site which the new login information belongs to;
obtaining, from the fingerprint sensor, the new fingerprint information matched with the new login information;
generating a new login-information configuration file corresponding to the new fingerprint information; and
adding the new login information and the website information of the website to the new login-information configuration file, and saving the new login-information configuration file.

3. The method according to claim 1, further comprising:
when a request for matching the fingerprint information with new login information is received, obtaining the new login information and website information of a web site which the new login information belongs to;
obtaining, from the fingerprint sensor, the fingerprint information matched with the new login information; and
adding the new login information and the website information of the website which the new login information belongs to the login-information configuration file corresponding to the fingerprint information, and saving the login-information configuration file.

4. The method according to claim 1, wherein:
the at least one website include multiple websites, and
the login-information configuration file includes website information of the multiple websites and login information of each of the corresponding multiple websites.

5. The method according to claim 1, wherein searching for a login-information configuration file corresponding to the fingerprint information includes:
searching locally for the login-information configuration file corresponding to the fingerprint information.

6. The method according to claim 1, further comprising:
synchronizing the login-information configuration file to a server,
wherein searching for the login-information configuration file corresponding to the fingerprint information comprises:
sending the fingerprint information to the server;
requesting the server to search for the login-information configuration file corresponding to the fingerprint information; and
receiving the login-information configuration file from the server.

7. The method according to claim 1, further comprising:
synchronizing the login-information configuration file to a server,
wherein searching for the login-information configuration file corresponding to the fingerprint information comprises:
searching for the login-information configuration file corresponding to the fingerprint information locally; and
when the login-information configuration file corresponding to the login information is not found locally, sending the fingerprint information to the server, requesting the server to search for the login-information configuration file corresponding to the fingerprint information, and receiving the login-information configuration file from the server.

8. An apparatus for implementing website fingerprint login, comprising:
a fingerprint information acquisition unit, configured to obtain fingerprint information to login at least one website from a fingerprint sensor;
a configuration file searching unit, configured to search for a login-information configuration file corresponding to the fingerprint information, wherein the login-information configuration file includes website information of the at least one website and login information of the at least one website; and
a login information auto-filling unit, configured to automatically fill a login page of the at least one website with the login information found in the login-information configuration file.

9. The apparatus according to claim 8, further comprising:
a website/login information acquisition unit, when the website/login information acquisition unit receives a request for matching new fingerprint information with new login information, configured to obtain the new login information and website information of a website which the new login information belongs to;
the fingerprint information acquisition unit, configured to obtain, from the fingerprint sensor, the new fingerprint information matched with the new login information from the fingerprint sensor;
a configuration file generation unit, configured to generate a new login-information configuration file corresponding to the new fingerprint information; and
a configuration file updating unit, configured to add the new login information and the website information of which the new login information belongs to the new login-information configuration file, and saves the new login-information configuration file.

10. The apparatus according to claim 8, further comprising:
a website/login information acquisition unit, when a request for matching the fingerprint information with new login information is received, configured to obtain the new login information and website information of a website which the new login information belongs to;
the fingerprint information acquisition unit, configured to obtain, from the fingerprint sensor, the new fingerprint information matched with the new login information from the fingerprint sensor; and
a configuration file updating unit, configured to add the new login information and the website information of the website which the new login information belongs to the login-information configuration file corresponding to the fingerprint information, and save the login-information configuration file.

11. The apparatus according to claim 8, wherein:
the at least one website include multiple websites, and
the login-information configuration file includes website information of the multiple websites and login information of each of the corresponding multiple websites.

12. The apparatus according to claim 8, wherein the configuration file searching unit includes:
a local searching unit, configured to search locally for the login-information configuration file corresponding to the fingerprint information.

13. The apparatus according to claim 8, further comprising a communication unit, configured to:
synchronize the login-information configuration file to a server; and
send the fingerprint information to the server, request the server to search for the login-information configuration file corresponding to the fingerprint information, and receive the login-information configuration file from the server.

14. The apparatus according to claim 8, further comprising:
a communication unit, configured to synchronize the login-information configuration file to a server,
wherein the configuration file searching unit comprises:
a local searching unit, configured to search for the login-information configuration file corresponding to the fingerprint information locally, wherein
the communication unit further configured to, when the login-information configuration file corresponding to the login information is not found locally, send the fingerprint information to the server, request the server to search for the login-information configuration file corresponding to the fingerprint information, and receive the login-information configuration file from the server.

15. A client terminal device, comprising:
a fingerprint sensor, configured to provide fingerprint information to login at least one web site;
a memory, configured to save a login-information configuration file corresponding to the fingerprint information, wherein the login-information configuration file includes website information of the at least one website and login information of the at least one website; and
a processor, configured to search the memory for the login-information configuration file corresponding to the fingerprint information and auto-fill a login page of the at least one website with the login information found in the login-information configuration file.

16. The client terminal device according to claim 15, further comprising:
an input module, configured to fill the login page of a website with new login information and input a request for matching new fingerprint information with the new login information,
wherein the processor obtains, from the fingerprint sensor, the new fingerprint information matched with the new login information, generates a new login-information configuration file corresponding to the new fingerprint information, adds the new login information and the website information of the website which the new login information belongs to the new login-information configuration file, and saves the new login-information configuration file.

17. The client terminal device according to claim 15, further comprising:
an input module, configured to fill the login page of a website with new login information and input a request for matching new fingerprint information with the new login information,
wherein the processor obtains, from the fingerprint sensor, the fingerprint information matched with the new login information, adds the new login information and the website information of the website which the new login information belongs to the login-information configuration file, and saves the login-information configuration file.

18. The client terminal device according to claim 15, wherein:
the at least one website include multiple websites, and
the login-information configuration file includes website information of the multiple websites and login information of each of the corresponding multiple websites.

19. The client terminal device according to claim 15, wherein the memory is located locally.

20. The client terminal device according to claim 15, further comprising:
a communication module, configured to synchronize the login-information configuration file to a server, wherein the processor, through the communication module, sends the fingerprint information to the server, requests the server to search for the login-information configuration file corresponding to the fingerprint information, and receives the login-information configuration file from the server.

21. The client terminal device according to claim 15, further comprising:
a communication module, configured to synchronize the login-information configuration file to a server, wherein
when the login-information configuration file corresponding to the login information is not found locally, the processor, through the communication module, sends the fingerprint information to the server, requests the server to search for the login-information configuration file corresponding to the fingerprint information, and receives the login-information configuration file from the server.

22. A computer readable storage medium, configured to store a computer program for executing one of the methods according to claims 1-7.
